(19) United States
(12) Patent Application Publication
(10) Pub. No.: US 2017/0046491 A1
(43) Pub. Date: Feb. 16, 2017

(54) DATA MINING SYSTEM AND METHOD FOR PREDICTING INFORMATION CONTENT FROM A NETWORK DATA STREAM

(71) Applicant: CoverMyMeds LLC, Columbus, OH (US)

(72) Inventors: Matthew A. Scantland, Columbus, OH (US); Alan Pendergrass, Hudson, OH (US); Troy Pendergrass, Hudson, OH (US); Mark Lorenz, Powell, OH (US); Robert Littleton, Columbus, OH (US); David Brady, Saratoga Springs, UT (US); Boyan B. Alexandrov, Hilliard, OH (US)

(21) Appl. No.: 15/233,731

(22) Filed: Aug. 10, 2016

Related U.S. Application Data
(60) Provisional application No. 62/205,582, filed on Aug. 14, 2015.

(51) Int. Cl. G06F 19/00; G06N 3/08; G06F 17/30

(52) U.S. Cl. CPC G06F 19/328; G06F 17/30539; G06F 17/30516; G06N 3/08

(57) ABSTRACT

A content extraction system can analyze a network data stream communicated among nodes of a network. The content extraction system can include non-transitory computer storage configured to store at least a portion of the network data stream and a hardware processor in communication with the non-transitory computer storage. The hardware processor can be programmed to access the at least a portion of the network data stream, apply a machine learning technique to the at least a portion of the network data stream to extract an information content, and store the information content in the non-transitory computer storage. In various implementations, the content extraction system can be applied to geographic information services, prescription medication information, or the Internet of Things.

### CROSS-REFERENCE TO RELATED APPLICATIONS

This application claims the benefit of priority under 35 U.S.C. §119(e) to U.S. Patent Application No. 62/205,582, filed Aug. 14, 2015, which is hereby incorporated by reference herein in its entirety for all it discloses.

### BACKGROUND

Field

Computer-implemented methods and apparatus are provided for predicting information content from a network data stream.

Description of the Related Art

In a networked computer system, a data stream can flow through the network to nodes on the network. Each of the nodes can comprise a hardware computing device that can receive, analyze, modify, store, and/or re-transmit the data (or a modified version of the data). Each node may execute one or more applications (or “apps”) that perform data management tasks using the data stream and/or locally stored data. Nodes can include servers, desktops, laptops, tablets, cellular telephones, and so forth. In the Internet of Things (IoT), nodes now commonly include household appliances, sensors (e.g., thermostats), automobiles, and so forth. Nodes can include embedded systems configured to perform a single function (or a few functions) such as measuring ambient temperature or pressure or turning on a switch. Nodes can communicate with each other via the network. Some nodes only communicate locally with other local nodes, while other nodes (sometimes referred to as edge nodes) act as a gateway to a global network (such as the Internet).

Nodes can communicate over wired or wireless networks, which may be configured according to a network standard such as WiFi, Bluetooth, IEEE 802.15.4, etc.

### SUMMARY

In an embodiment, a content extraction system can analyze a network data stream communicated among nodes of a network. The content extraction system can include non-transitory computer storage configured to store at least a portion of the network data stream and a hardware processor in communication with the non-transitory computer storage. The hardware processor can be programmed to access the at least a portion of the network data stream, apply a machine learning technique to the at least a portion of the network data stream to extract an information content, and store the information content in the non-transitory computer storage. In an implementation, the network data stream comprises traffic or accident information, and the information content comprises a predicted route that avoids the traffic or the accident. In another implementation, the network data stream comprises medical insurance claim information, and the information content comprises a predictive formulary of medications. In another implementation, the network data stream comprises sensor data communicated from a plurality of sensors that measure a parameter (e.g., household temperature) that is reflective of an electric load, and the information content comprises electric power usage.

The foregoing summary is intended to illustrate example embodiments and not to limit the scope of the disclosure.

### BRIEF DESCRIPTION OF THE DRAWINGS

FIG. 1 schematically illustrates an example network comprising nodes which exchange a data stream over the network and a content extraction system.

FIG. 2 is a flowchart that schematically illustrates an example of a method for extracting information content from a network data stream.

FIG. 3 schematically illustrates an example of a system for generating information content from a network data stream.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

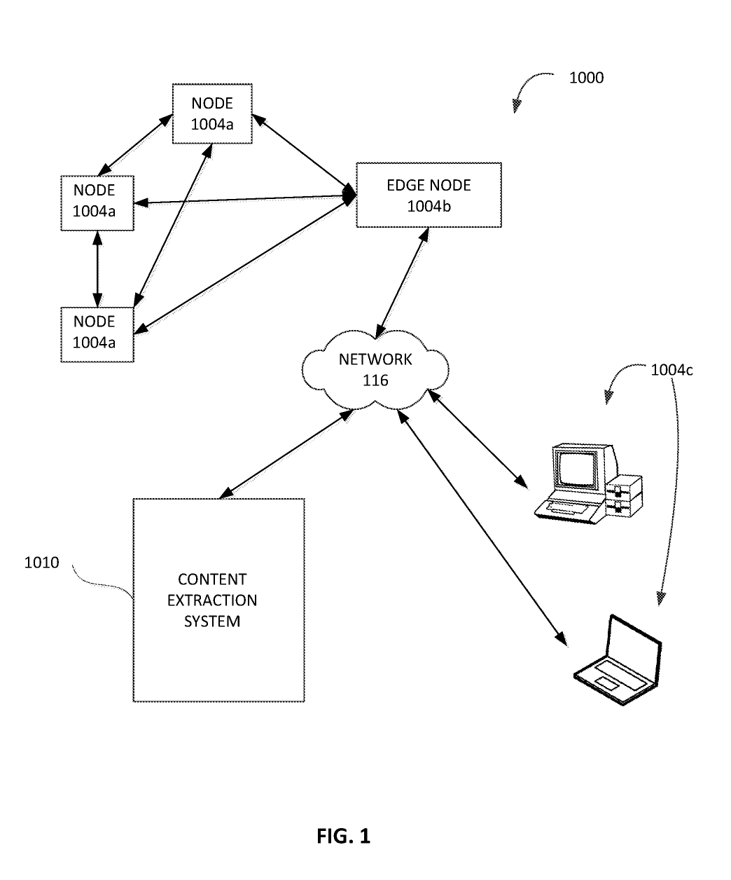

FIG. 1 schematically illustrates an example network 116 comprising nodes 1004a, 1004b, 1004c, which exchange a data stream over the network. A system 1000 for extracting information content from the network data stream can utilize a content extraction system 1010 that is in communication with one or more of the nodes 1004a, 1004b, 1004c to analyze the network data stream and to extract information content from the data stream. The nodes can comprise hardware computing devices such as servers, desktops, laptops, tablets, cellular telephones, and so forth. In the Internet of Things (IoT), nodes can commonly include household appliances, sensors (e.g., thermostats), automobiles, and so forth. Nodes can include embedded systems configured to perform a single function (or a few functions) such as measuring ambient temperature or pressure or turning on a switch. The network 116 can be wired, wireless, or a combination of wired and wireless.

In the example system 1000, the nodes 1004a are connected to each other and to an edge node 1004b. The nodes 1004a form a portion of a local area network (LAN), and, in this example, none of these nodes have a direct connection to the external network 116. For example, none of these nodes 1004a have a direct connection to the Internet. The edge node 1004b includes an internet protocol that permits the edge node 1004b to connect to the external network 116. Thus, the nodes 1004a are network-accessible through the edge node 1004b, and network data can stream to and/or from the nodes 1004a through the edge node 1004b. External nodes 1004c (e.g., laptops, cellular telephones, tablets, servers, other nodes, etc.) can send or receive data to or from the nodes 1004a, 1004b via the network 116. Accordingly, in this illustrative example, any of the nodes 1004a, 1004b, 1004c can access the data stream that passes through the network 116. The example in FIG. 1 is intended to be illustrative and not limiting, and in other implementations, different numbers, types, and configurations of the nodes 1004a, 1004b, 1004c can be utilized.

The system 1000 also includes the content extraction system 1010, which is also connected to the network 116 and can access the network data stream. The content extraction system 1010 can communicate with any of the nodes 1004a, 1004b, 1004c via the network 116. The content extraction system 1010 can comprise computing hardware and may be implemented on a server in some cases or in a cloud computing environment. The content extraction system 1010 can comprise non-transitory computer storage to store at least a portion of the network data stream and/or the information content extracted from the data stream. The content extraction system 1010 can receive a portion of the network stream and analyze the network stream to extract information from the network stream. For example, the content extraction system 1010 can analyze a portion of the network stream and predict information that is associated with the data in the network stream.

The content extraction system 1010 can use machine learning techniques to analyze the data stream so as to extract the appropriate information content. The machine learning techniques can include neural networks, support vector machines, fuzzy logic, inductive logic systems, belief networks, classifiers, Markov trees, decision trees, minimization techniques, and/or any other type of artificial intelligence technique.

As an example relating to a geographic information service (GIS), the nodes may include sensors that monitor traffic flow and accidents on roadways. The content extraction system 1010 can analyze the traffic flow and accident data to predict the best routes among the roadways or to predict routes that bypass congested areas or accidents.

As an example relating to the Internet of Things (IoT), the nodes may include temperature sensors (e.g., thermostats) in homes, and the content extraction system 1010 can extract temperature data from the network stream and analyze the temperature patterns to predict where electric power will be needed in an electric power grid as well as to predict other electric power usage patterns. Such analysis by the content extraction system may be particularly advantageous in hot summer months to help prevent electrical power shortages or outages.

As yet another example (which will be described in more detail below), the nodes can include health insurance provider computers and/or pharmacy computers, and the network data stream can include data relating to prescriptions for medication. The content extraction system 1010 can analyze this data stream to predict a list of medications (e.g., a formulary) that is provided under different health plans.

The foregoing are examples intended to illustrate different applications of the system 1000 and are not intended to be limiting. Additional details on some of these applications will be provided below.

### Example Content Extraction System for Predicting Formularies

### Overview of Prescription Medication Formularies and Prior Authorization

The cost of prescription drugs may be covered by a health insurance plan. At least a portion of the costs of prescription drugs covered by the health insurance plan may be paid on behalf of the patient by the health insurance provider. Other prescription drugs falling outside of the coverage of a health insurance plan must be paid for, in full, out of pocket by the patient or other recipient of such prescription drugs.

Whether a prescription drug is or is not covered by a health insurance plan is not always readily determinable. For example, certain dosages or concentrations of a prescription drug may be covered, while others are not. Likewise, a prescription drug covered as an accepted treatment for a first medical condition may not be covered to treat a different medical condition, because it may be uncertain whether the prescription drug constitutes an effective treatment for that different medical condition. A prescription for a drug with a generic equivalent available may also be covered, but only if there is a reason why the generic equivalent is unsuitable.

The cost of prescription medications may be covered by a health insurance plan. At least a portion of the costs of prescription medications covered by the health insurance plan may be paid on behalf of the patient by the health insurance provider. Other prescription medications falling outside of the coverage of a health insurance plan must be paid for, in full, out of pocket by the patient or other recipient of such prescription medications.

The list of prescription medications (brand-name or generic) that are covered (at some level) under an insurance company's health insurance plan is called the formulary for that health insurance plan. Prescription medications in a formulary are commonly grouped into tiers, and the amount of coverage (or co-pay required to be paid by the insured) depends on the tier of the formulary the medication is in. Many formularies have three tiers. The first tier has the lowest co-payment and usually includes generic medications. The second tier has a higher co-payment than the first tier and usually includes preferred brand-name medications. The third tier has the highest co-payment and usually includes non-preferred brand name medications. Medications may be non-preferred because they are not yet proven safe or effective for a given medical condition, or the insurance company has not negotiated a lower, preferred price with the brand-name medication supplier. Medications that are not listed in any tier in the formulary are not covered by the health insurance plan and require full payment by the insured.

There are many possible variations to a formulary. For example, each health insurance plan offered by an insurance company may have a different formulary. For the same insurance plan, the formulary may be different in different states. Further, formularies are not fixed permanently but change over time as new medications become available or replace older medications, medications are proven safe and effective, the premiums and co-payment policies of the insurance plan change, and so forth.

Accordingly, whether a prescription medication is or is not covered by a health insurance plan formulary (and what tier it may be in) is not always readily determinable. For example, certain dosages or concentrations of a prescription drug may be covered by the formulary, while others are not. Likewise, a prescription drug covered as an accepted treatment for a first medical condition may not be covered (or may be listed in a higher tier) to treat a different medical condition, because it may be uncertain whether the prescription drug constitutes an effective treatment for that different medical condition. A prescription for a brand-name drug with a generic equivalent available may also be covered in the formulary, but only if there is a reason why the generic equivalent is unsuitable.

A physician's decision about which medication to prescribe a patient is governed by factors other than the purely therapeutic. The reality of the patient's insurance also affects what drugs a doctor will prescribe. Different drugs may have similar therapeutic effects, and, although one might be preferable in a purely clinical sense, the patient's insurance might restrict its use or fail to cover it at all.

Commonly, a physician lacks precise information about what medications the patient's insurance carrier might cover and when, given that the physician may deal with multiple insurance carriers, each with a variety of different plans. Also, insurance carriers' formularies frequently change, so that even if a physician had some kind of reference, there is a strong possibility of its being out of date. Physicians are usually forced to write a prescription and hope for the best outcome for the patient under the patient's policy.

A patient may report back later that, according to the pharmacist, their insurance requires prior authorization (PA) for that drug before covering it. The physician can then attempt to write a different prescription and try again, or enter into the time-consuming process of obtaining prior authorization for the drug. Often, patients receiving such responses from pharmacists simply elect to abandon the prescription, with adverse health effects.

When it is unknown whether insurance coverage for a prescription drug is available, a request for prior authorization to fulfill a prescription for a drug under the coverage of a health insurance plan can be submitted to the health insurance plan. The request for PA may be a form (paper or electronic) with a number of information fields (e.g., patient and physician information, insurance plan information, drug information, etc.) to be completed by the pharmacy and/or prescribing physician. Each health insurance provider may have its own individual form for a particular drug and/or particular insurance plan. In one example of submitting such a request, the pharmacy fulfilling the drug prescription can enter the information pertaining to the patient, drug and health insurance plan into an appropriate form. The at-least-partially-completed PA request form can be transmitted to the physician who prescribed the drug and/or the patient in order to be completed before being submitted to the health insurance provider. The health insurance provider can then make a determination as to whether the patient's insurance plan provides at least some coverage for the prescribed drug (e.g., whether the drug is in the formulary for the patient's insurance plan and, if so, what tier the drug is in).

Electronic prior authorization platforms can make the PA request form accessible from within a user account associated with the prescribing physician. For example, the prescribing physician may access the PA platform via a network (such as the Internet) using a graphical user interface (e.g., a web browser). Examples of computerized methods and apparatus for accessing, completing, and processing prior authorization requests for prescription drugs are described in U.S. Patent Application Publication No. 2011/0257992 to Scantland et al., which is hereby incorporated by reference herein in its entirety for all it discloses (hereinafter referred to as the '992 Publication).

A prescribing physician or other authorized party affiliated with the physician (e.g., the physician's office staff) will generally be hereinafter referred to generically as the “prescriber” for the sake of brevity. Further, the term physician can include a medical doctor (MD), a doctor of osteopathic medicine (DO), a physician assistant (PA), an optometrist (DO), a podiatrist (DPM), a dentist (DDS or DDM), a veterinarian (DVM), an advanced practice medical nurse (APRN), a clinical pharmacist, a medical or nurse practitioner, a medical psychologist, or any other person authorized or licensed to prescribe medications. The term medication includes drugs, medicines, pharmaceuticals, medicaments, medicinal products, medical devices or appliances, or any other substance, device, or apparatus having properties for treating or preventing disease in humans or animals.

### Example Health Information Network Data Stream

In some cases, an entity (such as a PA facilitator) may have relationships with one or more nationwide pharmacy or supermarket chains to use the entity's PA platform for determining whether a PA is required for a prescribed medication. For example, the pharmacist may use a user interface on a networked computing device to determine whether a PA is required. Such a networked computing device can comprise a node in FIG. 1. If so, the user interface may communicate an electronic rejection message from the insurer to the pharmacist such as, e.g., “CLAIM REJECTED—PRIOR AUTHORIZATION WILL BE REQUIRED”. The PA platform may provide functionality that permits the pharmacist to substantially automatically prepare a filled-out-and-ready-for-doctor's-electronic-signature PA request. For example, this functionality can be enabled, because (at least in part), the electronic rejection message itself contains information necessary to at least partially complete the PA request.

Under these relationships, the pharmacies (which may represent a substantial fraction of all U.S. prescription medication claims) electronically copy the entity on all the prescription medication claims the pharmacies submit to insurance companies and all responses received from insurance companies to those claims. This insurance claims network data stream, which contains information about prescription medication demand for a statistically significant fraction of the entire U.S. pharmacy industry, may include information on claims to virtually all insurance plans and providers for almost any medication. The insurance claims data stream can be securely preserved in confidence to prevent unauthorized access or disclosure of confidential patient health information and to ensure that such information is handled in compliance with applicable law and regulations.

Embodiments of the content extraction system 1010 permit the formularies used by insurance providers to be reconstructed, to a statistically significant approximation, by using the information in the prescription medication claims in the network insurance claims data stream. Although the data stream in the present disclosure is described as originating from network traffic from pharmacies, this is for illustration and is not intended to be limiting. In other implementations, the electronic data stream can be received from one or more sources including pharmacies, pharmacy benefits managers, health insurance companies, the government (e.g., Medicaid or Medicare claims), and so forth. In some implementations, the insurance claim data stream is filtered to remove any individually identifiable patient health information (e.g., patient name) prior to extraction of the formularies from the data stream.

Examples of Extracting Predictive Formularies from the Network Data Stream

One use of this insurance claims data stream is to solve the problem of physicians not knowing whether a prescription they write will require prior authorization by a patient's insurer. PA facilitators can attempt to regularly contact all insurers and obtain static formularies for all plans in all states provided by all of the insurers. However, this is cumbersome, and such formularies are soon out of date.

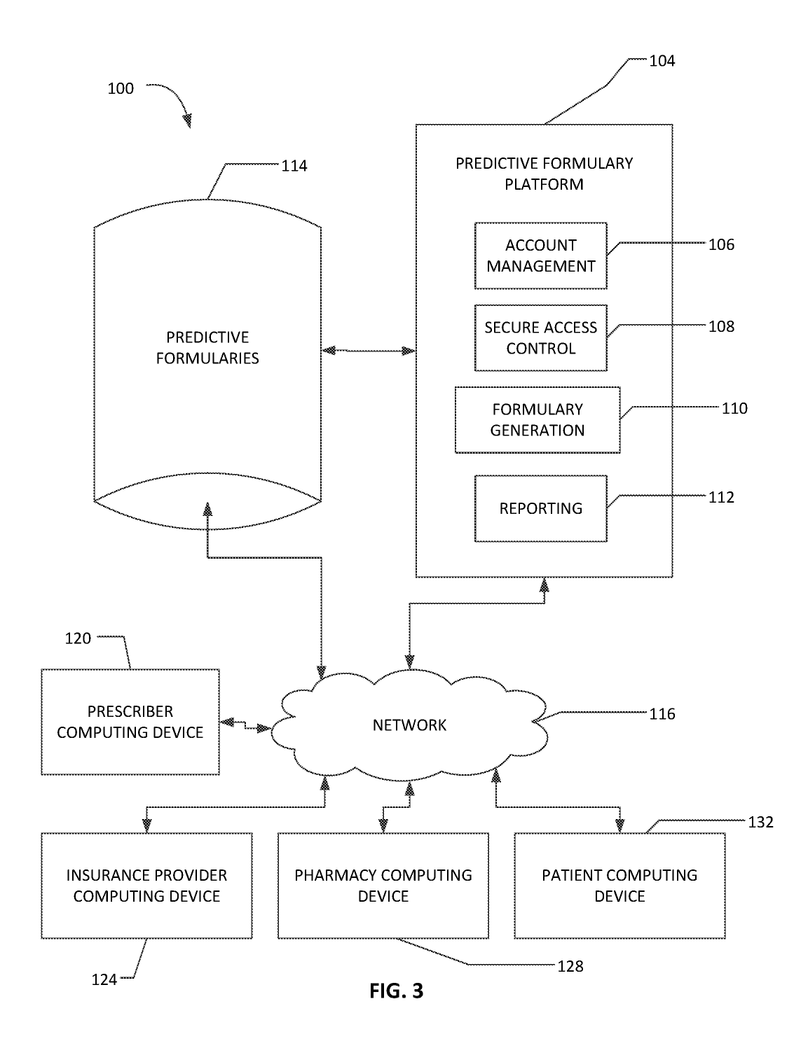

Accordingly, embodiments of the systems and methods of the present disclosure solve this problem by dynamically reverse-engineering the formularies of the insurance providers using (at least partly) the information in the insurance claims data stream. The following provides an example of a method for determining the formulary from the network data stream. The method can be performed by a PA platform (e.g., any of the systems described in the '992 Publication), by the content extraction system 1010 described with reference to FIG. 1, or by the example system 100 described with reference to FIG. 3.

At regular intervals, the method examines the insurance claims data stream, identifying claims and outcomes with specific combinations of, e.g., medications, dosages, insurers, and plans. In one implementation, the method can identify insurers and/or plans by looking at the claim's BIN (“bank identification number”—a pharmacy claim routing number, which works similarly to and was adapted from bank routing numbers), PCN (“processor control number”—which differentiates different plans within a given insurance claim processor) and/or RxGroup (which likewise can identify a specific group or pool within an insurance plan). With regards to the PCN, one PCN may mean “Blue Cross Blue Shield of North Carolina”, while another PCN may mean “Anthem Medicare Plan in Nevada”. Thus, the PCN can provide information about the insurer and the plan (and the state for the plan).

The predictive formulary systems and methods can identify drugs and/or dosages by looking at the claim's NDC number (“national drug code”), GPI (“generic product identifier”) number, and/or DDID (“dispensable drug identifier”) number, each of which are standard references that encapsulate a drug's name and dosage. For example, the NDC is a unique 10-digit, 3-segment numeric identifier assigned to each medication listed under Section 510 of the U.S. Federal Food, Drug, and Cosmetic Act. The segments identify the labeler or vendor, product (within the scope of the labeler), and trade package (of this product). The first segment, the labeler code, is 4 or 5 digits long and assigned by the Food and Drug Administration (FDA) upon submission of a Labeler Code Request. A labeler is any firm that manufactures, repacks or distributes a drug product. The second segment, the product code, is 3 or 4 digits long and identifies a specific strength, dosage form, and formulation for a particular firm. The third segment, the package code, is 1 or 2 digits long and identifies package forms and sizes. In very exceptional cases, product and package segments may have contained characters other than digits.

As an example, the insurance claims data stream permits the method to identify the following drug prescription was rejected by Standard Insurance under the patient's SuperGroup+ of Texas health plan: “Jun. 22, 2015 12:45 PM claim for 90 50 mg tablets of Placebin, submitted to Standard Insurance's SuperGroup+ of Texas Plan: REJECTED”. Thus, in this example, the medication, the dosage, the number of doses, the date and time of the claim, the insurance company, the plan, the state where the plan is available to patients, and the status of the claim (e.g., rejected in this example) can be determined from the data stream.

The method can optionally filter from these claims statistically meaningless items, such as refills, duplicates, and rejected claims that were immediately resubmitted and paid (indicating a data entry error by the pharmacist). In the context of the method, immediately refers to a very short time interval reflective of the processing time used to determine that the data entry was made in error by the pharmacist, for example, a time period of less than a fraction of a second, less than one second, less than ten seconds, less than one minute, less than five minutes, less than thirty minutes, less than one hour, or less than one day. The very short time interval is much less than the time interval during which another PA request could be made and received. This can improve the efficiency and accuracy of the analysis of the pharmacy data stream. As discussed above, the method can filter confidential patient health information from the data stream.

The method aggregates these claims, and analyzes them to identify patterns using statistical or data mining techniques. In some implementations, the method identifies combinations of medications and plans where the plan rejected more than a threshold percentage (e.g., 5%, 10%, 15%, or some other percentage) of claims. The method thereby can determine that these claims represent situations where the insurance company plan will require prior authorization for that particular medication or dosage. As an example, the method can determine that “On Jun. 22, 2015, Standard Insurance rejected 78% of all claims for 50 mg Placebin for customers in the SuperGroup+ of Texas plan. Standard Insurance must currently require prior authorization for this drug for SuperGroup+ of Texas insureds.”

The method stores these “will-require-prior-authorization” combinations determined from the pharmacy data stream in a non-transitory data storage (e.g., a database stored in a computer memory), creating a comprehensive, current formulary for all medications and insurance plans. Accordingly, the method advantageously can predict the current formulary for these medications and insurance plans. As additional data stream information is analyzed, the formulary for an insurance plan can be updated and as new data on new plans or insurers becomes available in the data stream, new formularies can be determined.

Due to the enormous volume of the claims information in the network data stream (e.g., millions of insurance claims), automatic extraction of the formularies from the data stream (e.g., using statistical or data mining techniques) provides formularies in which the listed medications, dosages, tiers, and so forth for any particular plan of an insurance provider can be performed with a high degree of statistical significance. For example, in some implementations the statistical significance can be measured by a p-value and the formulary accepted as statistically significant if the p-value is less than a threshold (e.g., 5%) In other implementations, the formulary may be accepted as statistically significant if the formulary is based on an analysis of greater than a threshold number of claims for the particular insurance provider and plan (e.g., greater than 1000 claims, 10,000 claims, or more claims).

### Example Uses of the Predictive Formulary

Computer applications can access the predictive formulary and look up a particular drug and plan to see if it is likely that prior authorization will be required. For example, the PA platform may provide an application programming interface (API) that provides routines, protocols, or tools for accessing the formulary. A software system in a computer device in a pharmacy or prescriber's office, for example, can use the APIs to permit a pharmacist to access the formulary and determine if it is likely that the medication is covered for a patient. As examples, “Standard Insurance SuperGroup+ of Texas/50 mg Xylor: COVERED OK” or “Standard Insurance SuperGroup+ of Texas/50 mg Placebin: PA WOULD BE REQUIRED”.

One possible application or use of this system is to provide advance warning for a physician that a prescription being written will require prior authorization. For example, the physician may utilize an electronic prescription (e-prescribing) software application in an electronic health record system to generate prescriptions for the physician's patients. The prescriber's electronic health record system typically has information stored for the patient's name, social security number, insurance provider, insurance plan, etc. The e-prescribing software can access the predictive formulary system API every time a prescriber begins creating a prescription for the patient, and receive back a prediction (from the predictive formulary system) as to what will happen if the claim is submitted to the patient's insurance provider. As an example, the e-prescribing system may provide a notification on a user interface of the electronic health record system such as: “Alert: You are writing a prescription for 50 mg Placebin. Your patient's insurer will probably require prior authorization for this drug.”

In some implementations, the formulary system could optionally suggest alternatives such to the e-prescribing system (as a notification to appear on a prescriber's user interface) as, e.g., “Alert: You are writing a prescription for 50 mg Placebin. Your patient's insurer will probably require prior authorization for this drug. You may wish to consider prescribing Xylor, which is therapeutically similar and which your patient's insurer will cover.”

Additionally or alternatively, the prescriber's e-prescribing system can begin creating a prior authorization request if the system detects that one will likely be needed. For example, “Alert: You are writing a prescription for 50 mg Placebin. Your patient's insurer will probably require prior authorization for this drug. Go ahead and submit prior authorization request?” The prescriber can choose to have the PA request prepared and submitted electronically to the patient's insurer (e.g., by selecting a button on the e-prescriber user interface).

Example Method for Extracting a Predictive Formulary from a Network Data Stream

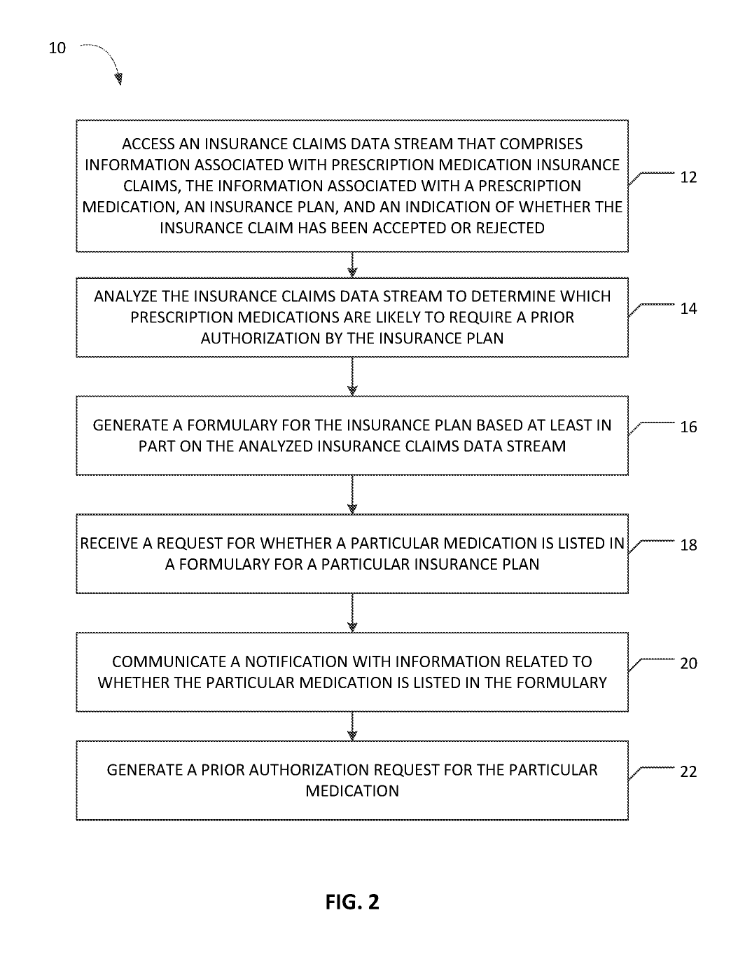

FIG. 2 is a flowchart that schematically illustrates an example of a method 10 for generating predictive formularies for prescription medications. The method 10 can be performed by a PA platform (e.g., any of the systems described in the '992 Publication), by the content extraction system 1010 described with reference to FIG. 1, or by the example system 100 described with reference to FIG. 3.

At block 12, the method 10 accesses an insurance claims data stream that comprises information associated with prescription medication insurance claims. The information is associated with a prescription medication, an insurance plan, and an indication of whether the insurance claim has been accepted or rejected. The data stream is transmitted by the network 116 among nodes of the network (e.g., pharmacy or insurance computing devices) and can be accessed by the content extraction system 1010, the system 100, or a PA platform. At block 14, the method 10 analyzes the insurance claims data stream to determine which prescription medications are likely to require a prior authorization by the insurance plan. At block 16, the method 10 generates a formulary for the insurance plan based at least in part on the analyzed insurance claims data stream.

In some implementations, the formulary generated at block 16 can be accessed by users such as prescribers, pharmacies, etc. The method 10 can include optional blocks 18-22. For example, at block 18, the method 10 can receive a request for whether a particular medication is listed in a formulary for a particular insurance plan. At block 20, the method 20 communicates a notification with information related to whether the particular medication is listed in the formulary. The notification can include information on whether a PA is likely to be required by the patient's health insurance plan, a recommendation for an alternate medication that is included in the formulary for the patient's health care plan (or is included in a tier having a lower co-pay), etc. At block 22, the method 10, if a PA is needed, can automatically generate a prior authorization request for the particular medication. The method 10 may permit the user to electronically submit the PA request for the medication (e.g., by receiving user input that the user desires the PA request to be submitted).

Example System for Extracting a Predictive Formulary from a Network Data Stream

FIG. 3 schematically illustrates an example of a system 100 for generating predictive formularies for prescription medications. The system 100 may, but need not, also process PA requests. The system 100 can perform embodiments of the method 10 described with reference to FIG. 2 or any of the other functionality described herein. For example, in some implementations, the system 100 generates the formularies, and the formularies are accessed by a prescriber's electronic health records system. The system 100 can implement the PA techniques described in the '992 Publication. The system 100 includes a predictive formulary platform 104 configured to communicate over the network 116 with one or more computing devices such as a prescriber computing device 120, an insurance provider computing device 124, a pharmacy computing device 128, or a patient computing device 132. The system 100 can communicate with non-transitory data storage 114 that stores the formularies predicted for the insurance providers. The predictive formulary platform 104 can receive the insurance claims data stream and perform statistical or data mining operations on the data stream to extract the predicted formularies. Some or all of the insurance claims data stream can be stored in the data storage 114. The computing devices 120, 124, 128, 132 can be embodiments of nodes 1004a, 1004b, 1004c described with reference to FIG. 1, and the predictive formulary platform 104 can provide the functionality of the content extraction system 1010 described with reference to FIG. 1.

As will be further discussed below, in certain implementations, the predictive formulary platform 104 can include various systems including an account management system 106, a secure access control system 108, a formulary generation system 110, and a reporting system 112. The predictive formulary platform 104 may be maintained by, or on behalf of, an entity that provides prior authorization services or electronic prescription services. In some implementations, the systems comprise computer hardware programmed with specific computer instructions to provide the associated functionality.

The predictive formulary platform 104 can be implemented on computer hardware, such as one or more physical computer servers programmed with specific computer-executable instructions. The computing devices 120-132 can include general purpose computers, servers, data input devices (e.g., terminals or displays), web interfaces, portable or mobile computers, laptops, or tablets, smart phones, etc. The computing devices 120-132 can include user interfaces to allow users to communicate with the predictive formulary platform 104 over the network 116. The computing devices 120-132 can additionally or alternatively include software applications that can communicate with the predictive formulary platform, for example by using a suitable Application Program Interface (API). The network 116 can provide wired or wireless communication between the computing devices 120-132 and the predictive formulary platform 104 or the data storage 114. The network 116 can be configured as a local area network (LAN), a wide area network (WAN), the Internet, an intranet, combinations of the same, or the like. In certain embodiments, the network 116 can be configured to support secure shell (SSH) tunneling or other secure protocol connections for the transfer of data between the predictive formulary platform 104 and the computing devices 120-132 or the data storage 114.

The predictive formulary platform 104 includes the account management system 106 that can handle creation and maintenance of user accounts on the platform. For example, a prescriber can access the predictive formulary platform via a user interface on the prescriber computing device 120 to request an account. The prescriber computing device 120 may operate an electronic health records system (including an e-prescription system) that facilitates interaction with the platform 104. The prescriber may be asked to provide publicly-available information that can include, for example, the prescriber's name, address, telephone number, facsimile (fax) number, electronic mail (email) address, and so forth. The prescriber can also be identified based at least in part on a prescriber identification token that is uniquely associated with the prescriber. For example, the prescriber identification token can include the physician's National Provider Identifier (NPI), which is a unique 10-digit identification number issued to health care providers in the United States by the Centers for Medicare and Medicaid Services as mandated by HIPAA. Information such as the NPI is commonly included with a prescription for the medication prescribed by the prescriber.

The account management system 106 may associate the account with the prescriber identification token so that the account can be uniquely identified. The prescriber may be able to access the account by utilizing a user interface that allows the prescriber to enter the prescriber identification token (e.g., the prescriber's NPI) and a password. The secure access control system 108 can be configured to verify that a party attempting to create an account on the platform 104 is actually the prescriber and not an impersonator. The secure access control system 108 can also provide security to prevent unauthorized access to or disclosure of the formularies or the insurance claims data stream stored in the data storage 114.

The predictive formulary platform 104 can facilitate the process of obtaining a PA for a prescription medication and/or facilitate the process for determining whether the patient will need a PA for the prescription medication. For example, the predictive formulary platform 104 can access the data storage 114 to determine if the medication is listed in a formulary associated with the patient's insurance provider and insurance plan. As described herein, if the prescription medication is not in the appropriate formulary. the system 100 can provide an notification to the prescriber's computing device 120 (or the pharmacy computing device) and may provide a notification with a suggested alternative that is in the formulary.

The formulary generation system 110 can perform the disclosed methods for generating a predicted formulary for an insurance plan and provider. For example, the formulary generation system 110 can analyze the insurance claims data stream received by the platform 104 to determine the formulary.

Additionally or alternatively, as described herein, the system 100 can check (during the e-prescribing process) whether the medication in question is known to the system 100 to be in the formulary associated with the patient's health insurance plan. If so, the prescriber's e-prescribing system can continue with the electronic prescription process. If the system 100 determines the medication in question is not in the formulary for the patient's plan, the system can communicate appropriate notifications to the prescriber computing device 120.

For example, if the system 100 determines the medication is not in the formulary, and the prescriber chooses to proceed with the prescription, the system 100 can determine that a PA request will be needed and can automatically begin generating the prior authorization request form for the prescriber for submission to the insurance provider. The system 100 can transmit the PA request to the insurance provider when the PA request is finalized. If the system 100 determines that an alternative medication (e.g., a generic formulation) is in the formulary, the system can notify the prescriber and provide a user-selectable feature (e.g., a button) that permits the prescriber to select the alternative for the prescription, which can be completed by the prescriber's e-prescription system.

The user can input information into the system 100 (e.g., via text entry fields in a PA form, a user interface, etc.). In some cases, the platform 104 may auto-populate one or more fields on the form or user interface. The form (or information entered into such forms) can be transmitted over the communication network 116. For example, a pharmacist may begin entry of information into the form or user interface but need additional information from the prescriber (or the patient) to complete the prescription or PA request before it is sent to the insurance provider. The platform 104 can communicate the form (or the appropriate information) to the prescriber or patient for completion.

The prescriber can access the partially-completed PA form by logging in to the prescriber's account on the platform 104. The prescriber can complete the remaining required fields on the form, electronically sign the form, and submit the form to the health insurance provider via the platform 104. Upon receiving the completed form, the health insurance provider can determine whether to approve, deny, cancel, or request additional information for the form. The health insurance provider can be an insurance company, a pharmacy benefits manager (PBM), an administrator of a prescription drug program, or other entity responsible or authorized to process and/or pay prescription medication claims.

The platform 104 can include the reporting system 112, which can perform various administrative functions for the system 100. For example, the reporting system 112 can perform reporting, auditing, logging, and other communication functions with managers, administrators, and users of the system 100. For example, the reporting system 112 can store a copy of the prescription or the PA request form (or the information used to populate the prescription or form). The reporting system 112 may also log (or store a log of) successful transactions or communications between, for example, a pharmacist and a prescriber and the prescriber.

### Additional Information

All of the processes and process steps described above (including those of FIG. 1) may be embodied in, and fully automated via, software code modules executed by one or more general purpose computers or computing devices programmed with specific computer-executable instructions. The code modules or the resulting data or output from the processes may be stored in any type of non-transitory computer-readable medium or other computer storage or storage device. As mentioned above, some or all of the methods or steps may alternatively be embodied in specialized computer hardware. The results of the disclosed methods and tasks may be persistently stored by transforming physical storage devices, such as solid state memory chips and/or magnetic disks, into a different state.

Thus, all of the methods and tasks described herein may be performed and fully automated by a programmed or specially configured computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other computer-readable storage medium.

Code modules may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes and process steps (or any data accessed or used) may be stored, persistently or otherwise, in any type of non-transitory, tangible computer storage or may be communicated via a computer-readable transmission medium.

Any processes, blocks, states, steps, or functionalities in methods or flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer or software product or packaged into multiple computer or software products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network (e.g., a terrestrial and/or satellite network) or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

Further, certain implementations of the functionality of the present disclosure are sufficiently mathematically, computationally, or technically complex that application-specific hardware or one or more physical computing devices (utilizing appropriate specialized executable instructions) may be necessary to perform the functionality, for example, due to the volume or complexity of the calculations involved or to provide results substantially in real-time. For example, the large number of possible prescription medications, the large number of formularies, and the large volume of data on nation-wide health insurance claims that may flow through the predictive formulary system typically require specifically programmed computer hardware to be necessary to process the data to predict the formularies in a commercially reasonable amount of time.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” or “an” or “the” as used in this application and any appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing description is intended to illustrate, and not limit, the inventive subject matter. The scope of protection is defined by the claims. In the following claims, any reference characters are provided for convenience of description only, and not to imply that the associated steps must be performed in a particular order.

What is claimed is:

1. A content extraction system for extracting information content from a network data stream, the content extraction system comprising:
non-transitory computer storage configured to store at least a portion of a network data stream;
a hardware processor in communication with the non-transitory computer storage, the hardware processor programmed to:
access the at least a portion of the network data stream;
apply a machine learning technique to the at least a portion of the network data stream to extract an information content; and
store the information content in the non-transitory computer storage.

2. The content extraction system of claim 1, wherein the non-transitory computer storage is in communication with a network which provides the network data stream.

3. The content extraction system of claim 2, wherein the network comprises a plurality of nodes and at least one edge node.

4. The content extraction system of claim 1, wherein the machine learning technique comprises one or more of: a neural network, a support vector machine, a fuzzy logic technique, an inductive logic system, a belief network, a classifier, a Markov tree, a decision tree, a minimization technique, or an artificial intelligence technique.

5. The content extraction system of claim 1, wherein the network data stream comprises traffic or accident information, and the information content comprises a predicted route that avoids the traffic or the accident.

6. The content extraction system of claim 1, wherein the network data stream comprises sensor data communicated from a plurality of sensors that measure a parameter that is reflective of an electric load, and the information content comprises electric power usage.

7. The content extraction system of claim 1, wherein the network data stream comprises medical insurance claim information, and the information content comprises a predictive formulary of medications.

8. A computer-implemented method for generating a formulary for a prescription medication, the method comprising:
under control of a predictive formulary platform comprising computer hardware:
accessing an insurance claims data stream that comprises information associated with prescription medication insurance claims, the information associated with a prescription medication, an insurance plan, and an indication of whether the insurance claim has been accepted or rejected;
analyzing the insurance claims data stream to determine which prescription medications are likely to require a prior authorization by the insurance plan; and
generating a formulary for the insurance plan based at least in part on the analyzed insurance claims data stream.

9. The computer-implemented method of claim 8, wherein analyzing the insurance claims data stream comprises determining an insurance plan based at least in part on a BIN number, a PCN number, or an RxGroup number associated with a claim in the data stream.

10. The computer-implemented method of claim 8, wherein analyzing the insurance claims data stream comprises determining a prescription medication or a dosage based at least in part on an NDC number, a GPI number, or a DDID number associated with a claim in the data stream.

11. The computer-implemented method of claim 8, further comprising filtering the claims in the data stream to remove claims for refills, duplicates, or rejected claims that were resubmitted and paid.

12. The computer-implemented method of claim 8, wherein generating the formulary comprises aggregating claim in the data stream and identifying patterns via a statistical technique or a data mining technique.

13. The computer-implemented method of claim 8, wherein generating the formulary comprises identifying combinations of medications and plans in which rejected claims exceed a threshold.

14. The computer-implemented method of claim 13, wherein the formulary for a plan includes medications in which the rejected claims exceed the threshold.

15. The computer-implemented method of claim 8, further comprising:
receiving a request for whether a particular medication is listed in a formulary for a particular insurance plan; and
communicating a notification with information related to whether the particular medication is listed in the formulary for the particular insurance plan.

16. The computer-implemented method of claim 15, further comprising generating a prior authorization request.

17. A system for generating a formulary for a prescription medication, the system comprising:
non-transitory computer storage configured to store at least a portion of the insurance claims data stream; and
a hardware processor in communication with the non-transitory computer storage and programmed to perform the method of claim 8.

18. Non-transitory computer storage comprising computer-executable instructions, that when executed by a hardware processor, cause the hardware processor to perform the method of claim 8.

19. An electronic prescription system, the system comprising:
non-transitory data storage configured to store health records for a plurality of patients, each health record including information relating to a health insurance provider and a health insurance plan for a patient associated with the health record; and
a hardware processor programmed to:
receive input relating to a prescription for a medication for a patient;
determine, from the health record for the patient, the health insurance provider for the patient;
access a predictive formulary to determine whether a request for prior authorization will be needed by the health insurance provider for the medication for the patient, the predictive formulary for the health insurance provider generated based on an analysis of an insurance claims data stream comprising claim information for the medication and the health insurance provider and the health insurance plan; and
provide a notification regarding whether a prior authorization request will be required by the health insurance provider.

20. The electronic prescription system of claim 19, wherein the notification comprises a recommendation to prescribe an alternative medication for which prior authorization is not required by the health insurance provider for the patient.

21. The electronic prescription system of claim 19, wherein the hardware processor is further configured to generate a prior authorization request for the medication.
